(19) United States
(12) Patent Application Publication
(10) Pub. No.: US 2017/0188750 A1
(43) Pub. Date: Jul. 6, 2017

(54) COOKING DEVICE WITH REMOVABLE AND RETROFITTABLE LIDS

(71) Applicant: MANITOWOC FOODSERVICE COMPANIES, LLC, New Port Richey, FL (US)

(72) Inventors: Roberto NEVAREZ, Hudson, FL (US); Eddy Zhou XING, Hangzhou (CN)

(21) Appl. No.: 15/392,553

(22) Filed: Dec. 28, 2016

Related U.S. Application Data
(60) Provisional application No. 62/273,587, filed on Dec. 31, 2015.

(51) Int. Cl. A47J 36/12; A47J 27/00

(52) U.S. Cl. CPC A47J 36/12; A47J 27/002

(57) ABSTRACT

The cooking device of the present disclosure has a housing and a cooking surface mounted in the housing. A plurality of lids is removably coupled to the housing. Each lid is pivotable between an open position and a closed position. The lids are elevated above the cooking surface when the lids are in the open position and contact the cooking surface when the lids are in the closed position. The lids capture steam and smoke released during cooking of the food product to add flavor and moisture to the food product.

### CROSS-REFERENCE TO RELATED APPLICATIONS

This application is claiming priority to U.S. Provisional Patent Application Ser. No. 62/273,587, filed on Dec. 31, 2015, the contents of which are hereby incorporated by reference.

### BACKGROUND OF THE DISCLOSURE

1. Field of the Disclosure

The present disclosure relates to cooking devices. More particularly, the present disclosure relates to cooking devices having a plurality of pivotable, removable lids.

2. Description of Related Art

There is a continuing need for cooking devices, such as griddles and charbroilers, that simplify the process of cooking different food products simultaneously. Many current devices have a single lid, requiring that food products on the cooking surface are either all covered or all uncovered. This makes cooking multiple products on a single cooking surface difficult to manage, since not all food products have the same cooking requirements.

The present disclosure addresses these deficiencies.

### SUMMARY OF THE DISCLOSURE

The present disclosure has a plurality of cooking zones mounted in a housing. Each cooking zone has a separate and removable lid that is structurally distinct from other lids. The lids can be pivoted upwardly for storage or removed if desired. A bracket is mounted to the housing. The lids and the bracket can be magnetically coupled together to secure the lids in an open position on the housing. Each of the cooking zones can be controlled independently to allow an operator to simultaneously cook different food products having different cooking requirements. The lids collect flare and smoke arising from the cooking surface to impart flavor and moisture to the food product. The present disclosure thus allows an operator to separately adjust parameters for each cooking zone, such as temperature, cook time, and whether the food product is covered or uncovered. This allows each food product to be cooked in a customized manner. Each lid further includes one or more vents to expel heated air, smoke, and grease vapors therethrough.

Thus, in one embodiment, the present disclosure provides a housing and a cooking surface mounted in the housing. A plurality of lids is removably coupled to the housing. Each lid is pivotable between an open position and a closed position. The lids are elevated above the cooking surface when in the open position and are lowered to contact the cooking surface when in the closed position. The lids capture steam and smoke released during cooking of the food product to add flavor and moisture to the food product.

### BRIEF DESCRIPTION OF THE DRAWINGS

FIG. 1 is a perspective view of the cooking device of the present disclosure, with two of the lids in the open position.

FIG. 2 is a top view of the cooking device of FIG. 1.

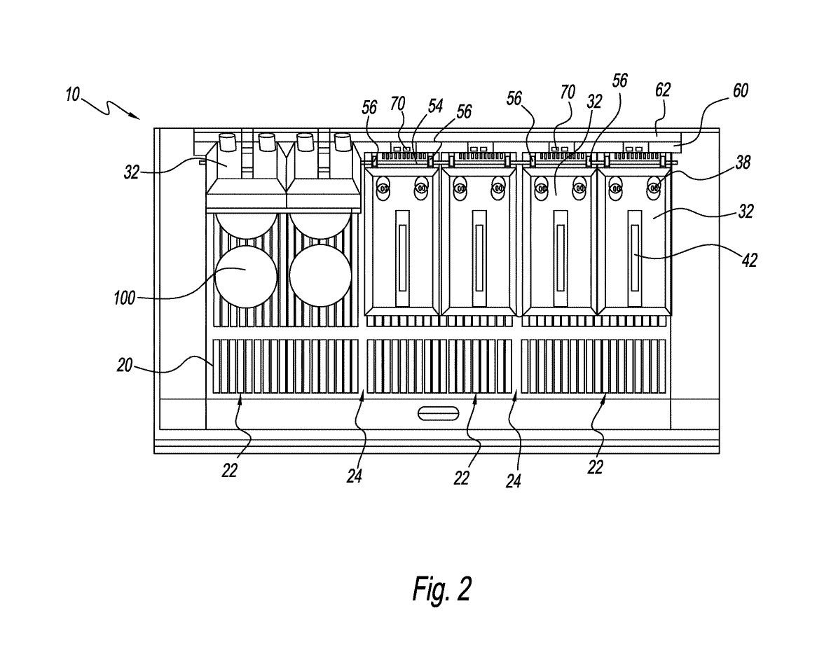

FIG. 3 is a first side view of the cooking device of FIG. 1, with at least one lid in the open position and at least one lid in the closed position.

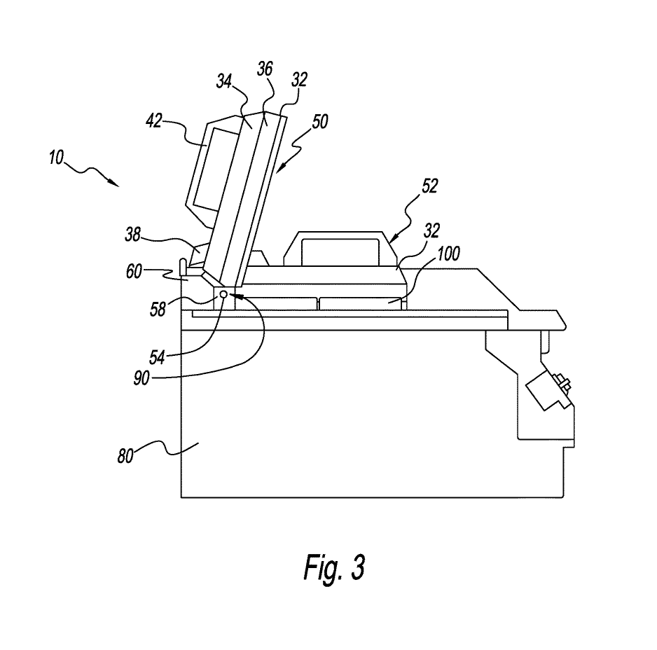

FIG. 4 is a front perspective view of the cooking device of FIG. 1, with alternative lids in the open position.

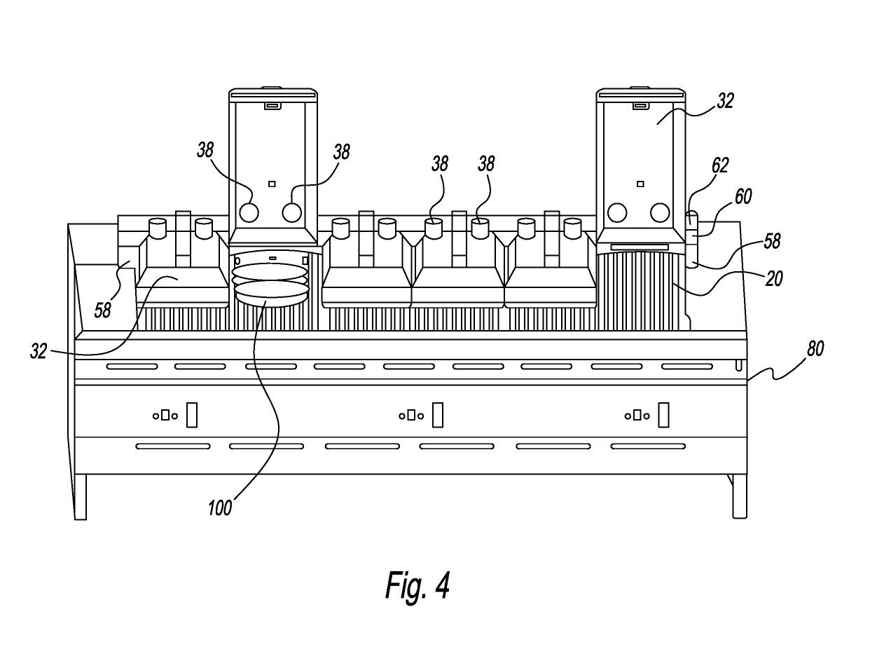

FIG. 5 is a perspective view of the cooking device of FIG. 1, with two central lids in the open position.

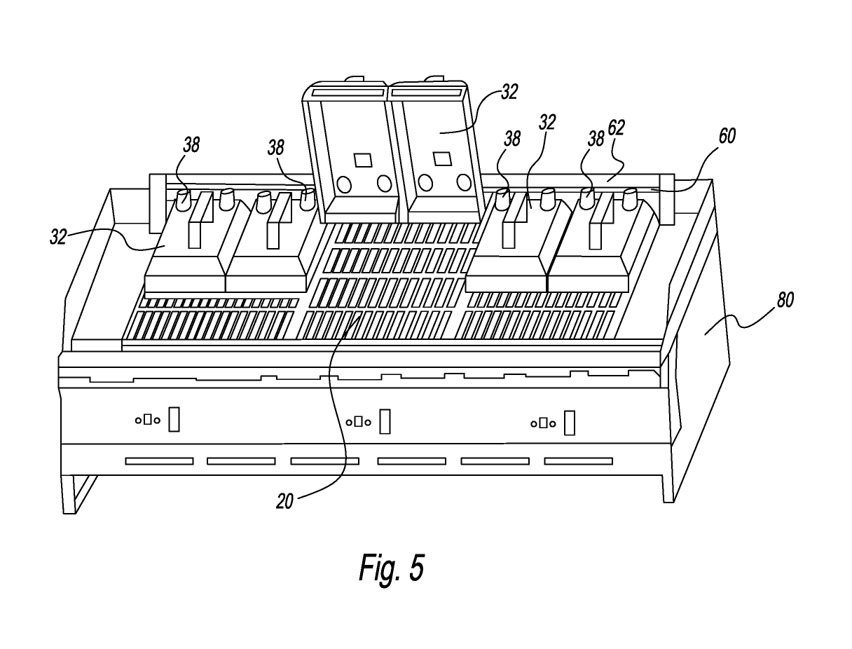

FIG. 6 is a perspective view of the cooking device of FIG. 1, showing only two lids attached to the housing.

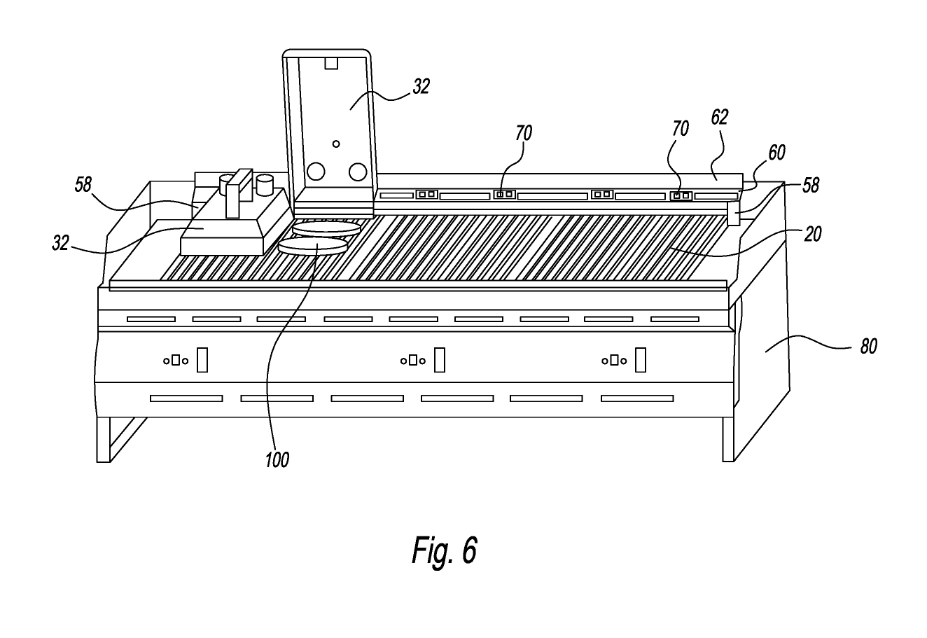

FIG. 7 is a second side view of the cooking device of FIG. 1, with a side panel of the housing removed.

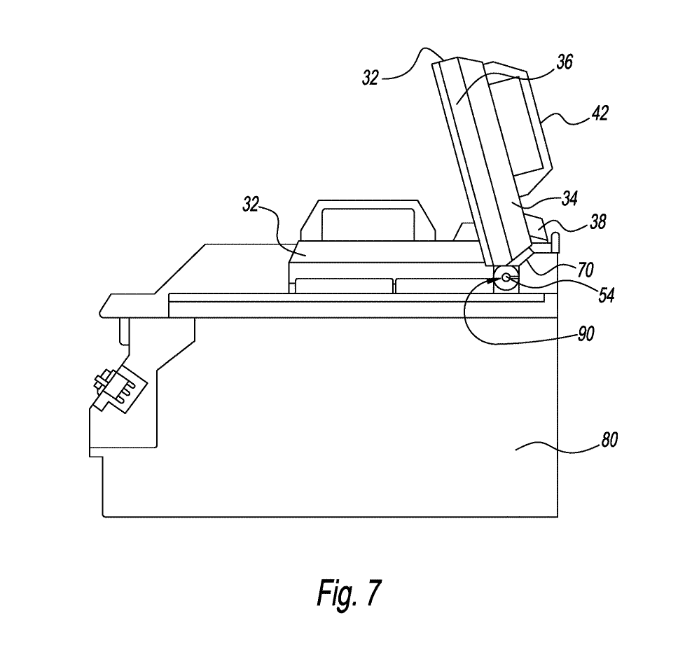

FIG. 8 is a top view of the cooking device of FIG. 1, showing two lids in the open position.

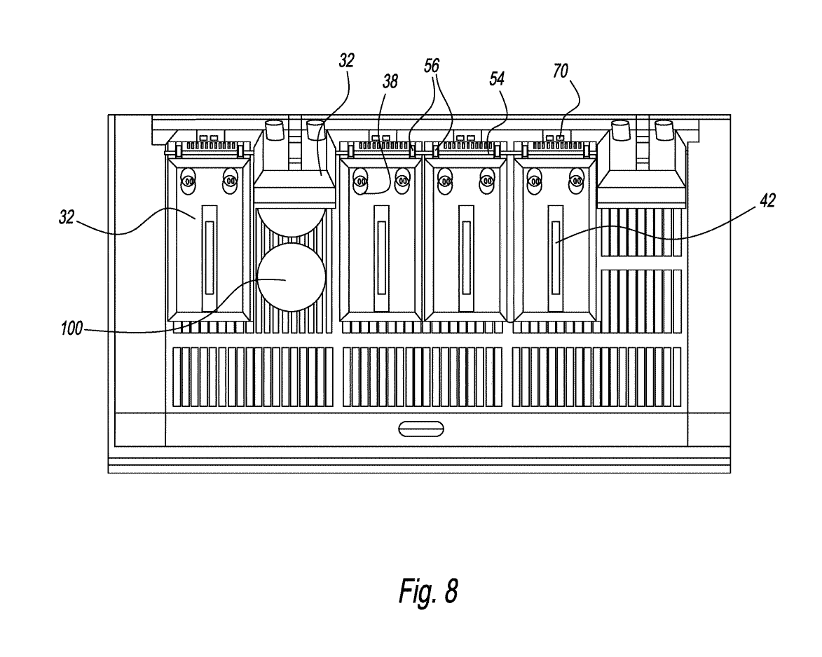

### DETAILED DESCRIPTION OF THE DISCLOSURE

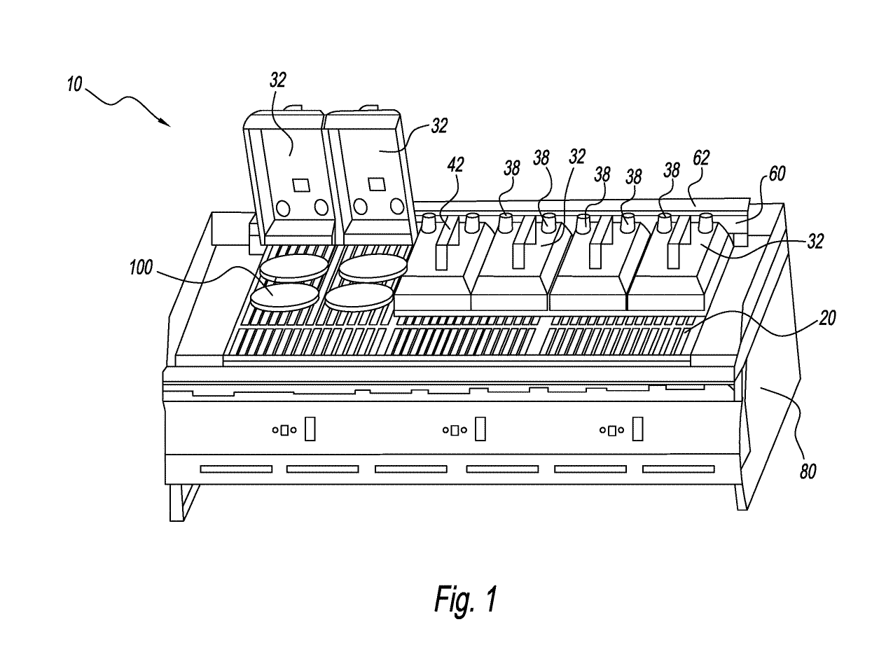

Referring to the Figures, and in particular FIG. 1, cooking device 10 is shown. Cooking device 10 has a cooking surface 20 mounted in a housing 80. As shown in the Figures, cooking device 10 can be a charbroiler wherein a plurality of grates defines the cooking surface 20. Alternatively, cooking device 10 can be a griddle having a broad flat surface that defines the cooking surface 20.

A plurality of lids 32 is provided. Each lid 32 is removably coupled to the housing 80, allowing the lids 32 to be removed from, or added to, the housing 80 as needed. Each lid 32 is pivotable toward and away from the cooking surface 20, allowing the lids 32 to selectively cover food products positioned on the cooking surface 20. Thus, the cooking device 10 of the present disclosure allows for flexibility and can be customized as needed.

A rod 54 extends along a single side of the cooking surface 20. Each of the lids 32 is pivotably couplable to the rod 54. Significantly, each lid 32 can be pivoted independently of the other lids 32. The lids 32 can be pivoted either manually or through programmed means. To facilitate manual movement of the lids 32 between their open 50 and closed 52 positions, each lid 32 can further include a handle 42.

In one embodiment, pivoting of the lids 32 is controlled by a program embedded on a controller (not shown). The controller can be in cooking device 10 or can be remotely disposed from cooking device 10. In this embodiment, opening and closing of the lids 32 is performed automatically based on instructions received from the controller. This opening and closing is coordinated with a cooking recipe or specific set of cooking parameters to ensure that the same type of food product can be cooked consistently each time.

A bracket 60 is mounted to the housing 80 and may also be mounted to a backsplash 62. A plurality of magnets 70 is provided and can be attached to either the bracket 60 or the lids 32 to allow magnetic coupling between each of the lids 32 and the bracket 60. The magnets 70 can be removably or permanently connected to either the bracket 60 or the lids 32. If the magnets 70 are on the bracket 60, the magnets 70 and the lids 32 are alignable such that when one of lids 32 is pivoted rearwardly toward the bracket 60, the associated magnet 70 grips the lid 32 to hold the lid 32 in the open position 50. This allows the lids 32 to be pivoted rearwardly into the open position 50 and stored out of the way when desired. The magnets 70 are preferably permanent magnets.

The particular location of the magnets 70 on either the bracket 60 or the lids 32, as well as the bend angle of the bracket 60 and/or backsplash 62, determines how far the lids 32 must pivot to reach the bracket 60 and secure the lids 32 in the open position 50. The location of the magnets 70, as well as the bend angle of the bracket 60 and/or backsplash 62, can be customized to allow the specific angle of the lids 32 relative to the cooking surface 20, when the lids 32 are in the open position 50, to be adjusted. For example, the bracket 60 can be bent to achieve a desired angle of the lids 32 relative to the cooking surface 20 when the lids 32 are in the open position 50. Thus, the lids 32 can form an acute angle, or a ninety-degree-angle or greater, with the horizontal when the lids 32 are in the open position 50. The adjustability of this angle provides ergonomic benefits, such as, for example, when an operator of the cooking device 10 has a short stature. In this example, the angle of the lids 32 relative to the cooking surface 20, when the lids 32 are in the open position 50, can be smaller to prevent the operator from having to reach as far back to pivot the lids 32.

A pair of pivot wheel tabs 56 is attached to each of the lids 32 for removably coupling the lids 32 to the rod 54. A pair of posts 58 is coupled to the housing 80 using fasteners, welding, or other conventional means. The posts 58 and the pivot wheel tabs 56 define a slot 90 that extends between the two posts 58 and through an interior surface of each of the pivot wheel tabs 56. The posts 58 hold the rod 54 within the slot 90. The rod 54 is rotatable in the slot 90 allowing the lids 32 to pivot between their open 50 and closed 52 positions. The lids 32 are slidable along the rod 54, and thus are slidable along a length of the housing 12. This allows the lids 32 to be re-positioned on the housing 12, or removed from the housing 12, as needed.

Rod 54 and bracket 60 can be of various sizes to accommodate cooking devices 10 of different sizes. For instance, bracket 60 can be of a greater size to permit use with lids 32 of a larger size.

Each cooking surface 20 can have one or more heating elements associated therewith. The heating elements can include gas, electric, and/or induction heating elements.

The cooking surface 20 can be divided into a plurality of distinct cooking zones 22. Each cooking zone 22 is heated by one or more of the heating elements. It is contemplated that there are at least two cooking zones 22, though more than two cooking zones 22 can be provided to accommodate an operator's needs. Gaps 24 can separate adjacent cooking zones 22 to facilitate independent operation of the cooking zones 22. Where the cooking surface 20 comprises grates, the grates can impart char marks to a food product 100 placed on one of the cooking zones 22. The lids 32 are positioned in the cooking zones 22, not between the cooking zones 22. As shown in the Figures, each cooking zone 22 can have one or more lids 32 associated therewith.

Having separate cooking zones 22 allows an operator to independently set the cooking parameters of each cooking zone 22. This ensures that different food products 100, with different cooking requirements, can be cooked on different settings simultaneously. Gaps 24 between cooking zones 22 help prevent the commingling of flavors when disparate food products 100 are cooked in adjacent cooking zones 22. This arrangement also allows the same type of food product 100 to be cooked in different cooking zones 22 using different settings.

Each lid 32 is positionable to cover at least part of the associated cooking zone 22. In the open position 50, the lids 32 are elevated above the cooking surface 20. In the closed position 52, the lids 32 contact the cooking surface 20. Lids 32 in the closed position 52 can enclose a food product 100 positioned on the respective cooking zone 22 thereby containing heat between the lid 32 and the cooking surface 20.

As shown in the Figures, at least one lid 32 is provided for each cooking zone 22. However, as described above, the present disclosure contemplates that there can be two or more lids 32 per cooking zone 22. Movement of the lids 32 provides independent access to their respective cooking zones 22. Lids 32 not in use can be removed from the housing 80 or pivoted upward into the open position 50. Moving the lids 32 into the open position 50 allows the lids 32 to remain out of the way, requiring no additional space for storage, yet ensures that the lids 32 are easily accessible when needed.

With the present disclosure, food products 100 can be sorted and placed according to various cooking requirements. For example, food products that need to be smoldered can be placed in a cooking zone 22 and covered with a lid 32. Food products that require less cooking time and/or food products that need to be turned over regularly to avoid being overcooked can be placed in a cooking zone 22 and left uncovered.

Although all lids 32 are shown in the Figures as being equally-sized, it should be understood that the lids 32 can be different sizes to accommodate, i.e., enclose, larger and smaller food products 100. The lids 32 can partially cover the associated cooking zone 22, as shown in the Figures, or alternatively, can extend over and fully cover the associated cooking zone 22.

Each lid 32 has a top wall 34 and a perimeter wall 36 coupled to and extending downwardly from the top wall 34. The perimeter wall 36 of each lid 32 can include four sides to ensure that food product 100 is trapped between the cooking surface 20 and the lid 32 when the lid 32 is in the closed position 52 so that the lid 32 completely covers the food product 100. This arrangement captures steam and smoke released during cooking to add flavor and moisture to the food product 100.

In one embodiment, each lid 32 further includes one or more vents 38 to expel heated air, smoke, and grease vapors therethrough. Thus, air that is captured between a lid 32 and the cooking surface 20 when the lid 32 is in the closed position 52 is directed outwardly through the vents 38 to the external atmosphere. In this manner, the vents 38 release vapors, air, etc. produced during cooking to prevent cooking device 10 from becoming over-pressurized. The vents 38 may be positioned in the top wall 34 of the lids 32. This is an improvement over many prior art cooking devices, which often vent gases and smoke through a slot in the back of the housing. Venting through the back of the housing directs smoke and gases toward a person facing the operator and effectively prevents others from standing opposite the operator while the grill is being operated. Providing vents 38 in the top wall 34 allows vapors and the like to be released while the lids 32 are in the closed position 52 without significantly affecting the operator or those standing near the operator.

In another embodiment, each lid 32 is hollow and functions as a vent to direct smoke and steam released during cooking. The lids 32 are able to provide variable venting depending on the angle of the lid 32 relative to horizontal. In this manner, the lids 32 act as smoke stacks to guide the natural air flow out of the hollow lid 32 and into the atmosphere, thereby adding flavor and accelerating the cooking process.

Charbroiler 10 can be provided and sold as a single unit. Alternatively, the lids 32 and bracket 60 can be quickly and easily retrofitted onto any grill to provide a customized cooking experience.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiments disclosed as the best mode contemplated for carrying out this disclosure.

What is claimed is:

1. A cooking device comprising:
a housing;
a cooking surface mounted in said housing for cooking a food product on said cooking surface; and
a plurality of lids removably coupled to said housing, each said lid being pivotable between an open position and a closed position, wherein each said lid is elevated above said cooking surface when said lid is in the open position and contacts said cooking surface when said lid is in the closed position, and wherein said lids capture steam and smoke released during cooking of the food product to add flavor and moisture to the food product.

2. The cooking device of claim 1, further comprising a bracket coupled to said housing, each said lid being magnetically couplable to said bracket for securing said lids in the open position.

3. The cooking device of claim 1, wherein each said lid has a top wall and a perimeter wall coupled to and extending downwardly from said top wall, each said perimeter wall having four sides such that each said lid fully encloses the food product between said cooking surface and said lid when said lid is in the closed position.

4. The cooking device of claim 1, wherein each said lid includes a vent for releasing smoke and air from an interior space of said lid when said lid is in the closed position.

5. The cooking device of claim 1, wherein each of said lids is independently pivotable.

6. The cooking device of claim 1, wherein said cooking surface comprises a plurality of grates.

7. The cooking device of claim 1, wherein said cooking surface is a single planar surface.

8. The cooking device of claim 1, wherein said cooking surface is divided into a plurality of distinct cooking zones.

9. The cooking device of claim 8, wherein each said cooking zone has an associated one of said lids associated therewith that at least partially covers said cooking zone.

10. The cooking device of claim 1, further comprising a rod extending along a single side of said cooking surface, wherein each said lid is pivotally coupled to said rod.

11. The cooking device of claim 1, further comprising a rod extending along a single side of said cooking surface, each said lid being slidable along said rod.

12. The cooking device of claim 1, wherein each said lid is hollow and thereby functions as a vent to direct air out of said lid and into the atmosphere.

13. The cooking device of claim 1, wherein movement of said lids between the open position and the closed position is controlled automatically based on a cooking recipe or a set of cooking parameters.

14. The cooking device of claim 4, wherein said vent of each lid is in a top wall of said lid.

15. The cooking device of claim 9, wherein at least one of said cooking zones has more than one said lid associated therewith.

16. The cooking device of claim 10, wherein rotation of said rod allows said lids to pivot between said open and closed positions.

17. The cooking device of claim 8, wherein gaps separate said cooking zones.

18. The cooking device of claim 1, wherein an angle that each said lid forms with said cooking surface when said lid is in the open position is selectively adjustable.

19. The cooking device of claim 1, wherein each said lid can be removed from or added to said housing.

20. The cooking device of claim 9, wherein each said lid fully covers said associated cooking zone.
